(19) United States
(12) Patent Application Publication
(10) Pub. No.: US 2024/0007416 A1
(43) Pub. Date: Jan. 4, 2024

(54) DISCOVERY OF REMOTE RESOURCE PROVIDERS FOR OFFLOADING COMPUTATIONAL PROCESSES

(71) Applicant: GM Global Technology Operations LLC, Detroit, MI (US)

(72) Inventors: Shige Wang, Northville, MI (US); Paolo Giusto, Brentwood, CA (US); Daniel Bouie, Sunnyvale, CA (US); Frances H. James, Sunnyvale, CA (US)

(21) Appl. No.: 17/810,383

(22) Filed: Jul. 1, 2022

(51) Int. Cl. H04L 47/765; H04L 47/78; H04L 47/70; H04L 45/00

(52) U.S. Cl. CPC H04L 47/765; H04L 47/781; H04L 47/822; H04L 45/20

(57) ABSTRACT

A system comprises a computer including a processor and a memory. The memory includes instructions such that the processor is programmed to: generate a resource query, the resource query comprising a request for resources for offloading at least one computation process and including at least one termination condition. The processor is also programmed to transmit the resource query to at least one remote resource provider and initiate an offload operation to offload the at least one computation process based on a received resource request.

### INTRODUCTION

The present disclosure relates to selecting a system that can discover and offload computing resources within a surrounding environment.

Vehicles can employ vehicle-to-vehicle (V2V) and vehicle-to-infrastructure (V2I) communications to communicate with other computing devices within a surrounding environment.

### SUMMARY

A system comprises a computer including a processor and a memory. The memory includes instructions such that the processor is programmed to: generate a resource query, the resource query comprising a request for resources for offloading at least one computation process and including at least one termination condition. The processor is also programmed to transmit the resource query to at least one remote resource provider and to initiate an offload operation to offload the at least one computation process based on a received resource request.

In other features, the termination condition comprises at least one of a time-based termination condition, a hop-count-based termination condition, a first-match termination condition, or a time-to-live termination condition.

In other features, the resource query further comprises an incentive that includes an upper threshold of compensation for using remote computational resources of the at least one remote resource provider.

In other features, the processor is further programmed to rank a plurality of resource providers based on resource requests received from the plurality of resource providers.

In other features, the at least one remote resource provider comprises at least one of an edge server, a V2X device, or a mobile computing device.

In other features, the processor is further programmed to generate the resource query according to a predefined policy.

In other features, the predefined policy comprises at least one of detecting a presence of the at least one remote resource provider, whether an ego-vehicle is entering a predetermined driving scenario, or one or more computing resources is predicted to be overloaded.

In other features, the processor is further programmed to transmit the resource query to a set of pre-authenticated resource providers according to a predefined transmission policy.

In other features, the at least one remote resource provider is configured to access a resource record to determine whether the at least one remote resource provider can provide computational resources defined within the resource query.

In other features, the at least one remote resource provider is configured to discard the resource query when the at least one remote resource provider determines that it cannot provide sufficient computational resources.

In other features, the at least one remote resource provider is configured to determine whether the at least one termination condition is met after receiving the resource request.

In other features, the at least one remote resource provider is configured to discard the resource query when the at least one termination condition is met.

A method includes generating a resource query. The resource query including at least a request for resources to offload at least one computation process and at least one termination condition. The method also includes transmitting the resource query to at least one remote resource provider and initiating an offload operation to offload the at least one computation process based on a received resource request.

In other features, the termination condition comprises at least one of a time-based termination condition, a hop-count-based termination condition, a first-match termination condition, or a time-to-live termination condition.

In other features, method further includes transmitting the resource query to a set of pre-authenticated resource providers according to a predefined transmission policy.

In other features, the at least one remote resource provider is configured to access a resource record to determine whether the at least one remote resource provider can provide computational resources defined within the resource query.

In other features, the at least one remote resource provider is configured to discard the resource query when the at least one remote resource provider determines that it cannot provide sufficient computational resources.

In other features, the at least one remote resource provider is configured to determine whether the at least one termination condition is met after receiving the resource request.

In other features, the at least one remote resource provider is configured to discard the resource query when the at least one termination condition is met.

In other features, the at least one remote resource provider comprises at least one of an edge server, a V2X device, or a mobile computing device.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a block diagram of an example system including a vehicle;

FIG. 2 is a block diagram of an example computing device;

FIG. 3 is a state diagram illustrating a resource requestor initiating a discovery protocol to identify one or more resource providers;

FIG. 4 is a block diagram illustrating a resource requestor;

FIG. 5 is a block diagram illustrating a resource provider;

FIG. 6 is a flow diagram illustrating an example process for generating a resource query at an ego-vehicle; and

FIG. 7 is a flow diagram illustrating an example process for discovering one or more devices that can function as resource providers.

### DETAILED DESCRIPTION

The following description is merely exemplary in nature and is not intended to limit the present disclosure, application, or uses.

Some vehicles, such as autonomous vehicles, employ vehicle-to-vehicle (V2V) and vehicle-to-infrastructure (V2I) communications, collectively known as V2X, for communication purposes. For example, V2X communications include one or more communication networks in which vehicles and roadside devices are the communicating nodes that provide one another with information, such as safety warnings and traffic information. V2X communications allow vehicles to communicate with other vehicles, infrastructure, and/or pedestrians, using wireless communications technologies such as, but not limited to, cellular, Bluetooth®, IEEE 802.11, dedicated short range communications (DSRC), ultra-wideband (UWB), and/or wide area networks (WAN).

The present disclosure is directed to a system and a process for discovering resource providers that can be used to off-load computation processes. More specifically, the system can use a discovery protocol that comprises a single round of communication that mitigates overhead with relatively quick responses as well as that include one or more termination conditions.

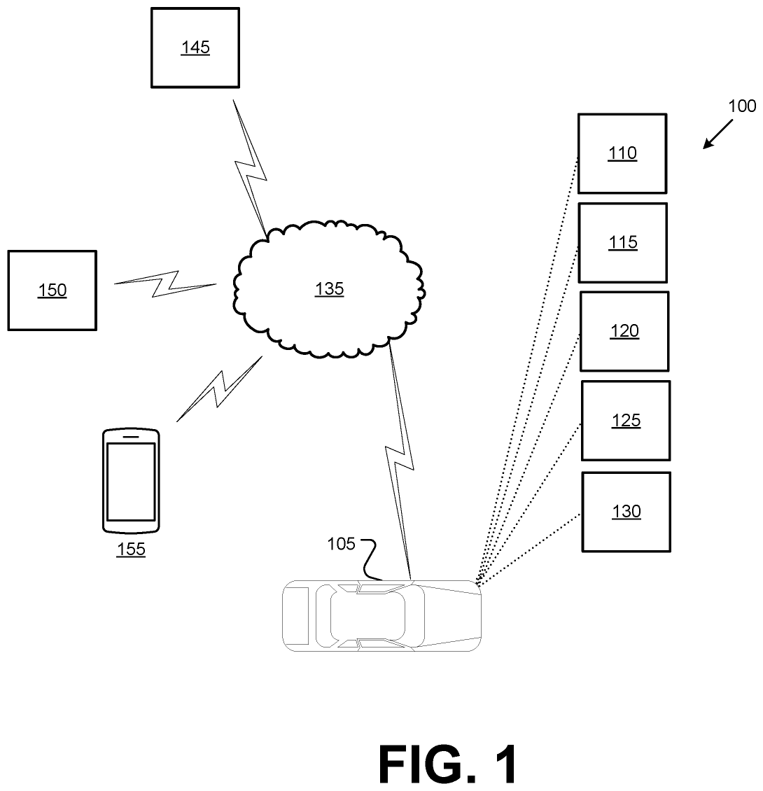

FIG. 1 is a block diagram of an example system 100. The system 100 includes a vehicle 105, which can comprise a land vehicle such as a car, truck, etc., an aerial vehicle, and/or an aquatic vehicle. The vehicle 105 includes a computer 110, vehicle sensors 115, actuators 120 to actuate various vehicle components 125, and a vehicle communications module 130. Via a network 135, the communications module 130 allows the computer 110 to communicate with a server 145.

The computer 110 may operate a vehicle 105 in an autonomous, a semi-autonomous mode, or a non-autonomous (manual) mode. For purposes of this disclosure, an autonomous mode is defined as one in which each of vehicle 105 propulsion, braking, and steering are controlled by the computer 110; in a semi-autonomous mode the computer 110 controls one or two of vehicles 105 propulsion, braking, and steering; in a non-autonomous mode a human operator controls each of vehicle 105 propulsion, braking, and steering.

The computer 110 may include programming to operate one or more of vehicle 105 brakes, propulsion (e.g., control of acceleration in the vehicle by controlling one or more of an internal combustion engine, electric motor, hybrid engine, etc.), steering, climate control, interior and/or exterior lights, etc., as well as to determine whether and when the computer 110, as opposed to a human operator, is to control such operations. Additionally, the computer 110 may be programmed to determine whether and when a human operator is to control such operations.

The computer 110 may include or be communicatively coupled to, e.g., via the vehicle 105 communications module 130 as described further below, more than one processor, e.g., included in electronic controller units (ECUs) or the like included in the vehicle 105 for monitoring and/or controlling various vehicle components 125, e.g., a powertrain controller, a brake controller, a steering controller, etc. Further, the computer 110 may communicate, via the vehicle 105 communications module 130, with a navigation system that uses the Global Position System (GPS). As an example, the computer 110 may request and receive location data of the vehicle 105. The location data may be in a known form, e.g., geo-coordinates (latitudinal and longitudinal coordinates).

The computer 110 is generally arranged for communications on the vehicle 105 communications module 130 and also with a vehicle 105 internal wired and/or wireless network, e.g., a bus or the like in the vehicle 105 such as a controller area network (CAN) or the like, and/or other wired and/or wireless mechanisms.

Via the vehicle 105 communications network, the computer 110 may transmit messages to various devices in the vehicle 105 and/or receive messages from the various devices, e.g., vehicle sensors 115, actuators 120, vehicle components 125, a human machine interface (HMI), etc. Alternatively or additionally, in cases where the computer 110 actually comprises a plurality of devices, the vehicle 105 communications network may be used for communications between devices represented as the computer 110 in this disclosure. Further, as mentioned below, various controllers and/or vehicle sensors 115 may provide data to the computer 110. The vehicle 105 communications network can include one or more gateway modules that provide interoperability between various networks and devices within the vehicle 105, such as protocol translators, impedance matchers, rate converters, and the like.

Vehicle sensors 115 may include a variety of devices such as are known to provide data to the computer 110. For example, the vehicle sensors 115 may include Light Detection and Ranging (lidar) sensor(s) 115, etc., disposed on a top of the vehicle 105, behind a vehicle 105 front windshield, around the vehicle 105, etc., that provide relative locations, sizes, and shapes of objects and/or conditions surrounding the vehicle 105. As another example, one or more radar sensors 115 fixed to vehicle 105 bumpers may provide data to provide and range velocity of objects (possibly including second vehicles 106), etc., relative to the location of the vehicle 105. The vehicle sensors 115 may further include camera sensor(s) 115, e.g., front view, side view, rear view, etc., providing images from a field of view inside and/or outside the vehicle 105.

The vehicle 105 actuators 120 are implemented via circuits, chips, motors, or other electronic and or mechanical components that can actuate various vehicle subsystems in accordance with appropriate control signals as is known. The actuators 120 may be used to control components 125, including braking, acceleration, and steering of a vehicle 105.

In the context of the present disclosure, a vehicle component 125 is one or more hardware components adapted to perform a mechanical or electro-mechanical function or operation-such as moving the vehicle 105, slowing or stopping the vehicle 105, steering the vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a brake component (as described below), a park assist component, an adaptive cruise control component, an adaptive steering component, a movable seat, etc.

In addition, the computer 110 may be configured for communicating via a vehicle-to-vehicle communication module or interface 130 with devices outside of the vehicle 105, e.g., through a vehicle to vehicle (V2V) or vehicle-to-infrastructure (V2X) wireless communications to another vehicle, to (typically via the network 135) a remote server 145, such as an edge server. The module 130 could include one or more mechanisms by which the computer 110 may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the module 130 include cellular, Bluetooth®, IEEE 802.11, dedicated short-range communications (DSRC), and/or wide area networks (WAN), including the Internet, providing data communication services.

The network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, Bluetooth Low Energy (BLE), IEEE 802.11, vehicle-to-vehicle (V2V) such as Dedicated Short-Range Communications (DSRC), etc.), local area networks (LAN) and/or wide area networks (WAN), including the Internet, providing data communication services.

The system 100 also includes an V2X device 150, which can communicate with the server 145 and the vehicle 105 via the communication network 135. While only a single V2X devices 150 is illustrated, it is understood that the system 100 can include multiple V2X devices 150 deployed throughout a traffic environment traversable by the vehicle 105. The V2X device 150 may comprise roadside devices, traffic lights, cameras attached to structures, edge devices, or any other Vehicle-to-Infrastructure (V2I) devices.

The system 100 can also include a computing device 155 that can communicate with the vehicle 105, the server 145, and/or the V2X device(s) 150 via the communication network 135. The computing device 155 can comprise any suitable computing device, such as a mobile electronic device, a laptop, a desktop, computing devices associated with other vehicles, or the like.

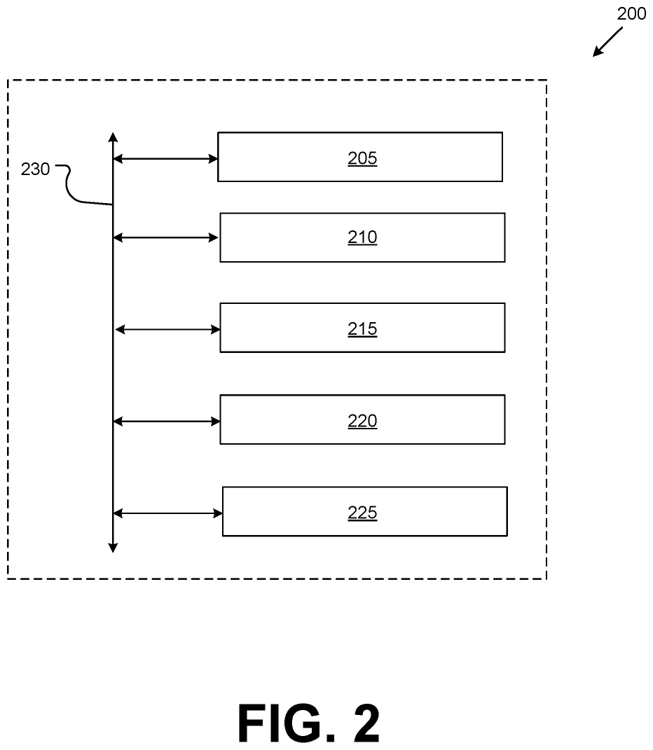

FIG. 2 illustrates an example computing device 200 i.e., computer 110, server(s)145, V2X device 150, and/or computing device 155, that may be configured to perform one or more of the processes described herein. As shown, the computing device can comprise a processor 205, memory 210, a storage device 215, an I/O interface 220, and a communication interface 225. Furthermore, the computing device 200 can include an input device such as a touchscreen, mouse, keyboard, etc. In certain implementations, the computing device 200 can include fewer or more components than those shown in FIG. 2.

In particular implementations, processor(s) 205 includes hardware for executing instructions, such as those making up a computer program. As an example, and not by way of limitation, to execute instructions, processor(s) 205 may retrieve (or fetch) the instructions from an internal register, an internal cache, memory 210, or a storage device 215 and decode and execute them.

The computing device 200 includes memory 210, which is coupled to the processor(s) 205. The memory 210 may be used for storing data, metadata, and programs for execution by the processor(s). The memory 210 may include one or more of volatile and non-volatile memories, such as Random-Access Memory (“RAM”), Read Only Memory (“ROM”), a solid-state disk (“SSD”), Flash, Phase Change Memory (“PCM”), or other types of data storage. The memory 210 may be internal or distributed memory.

The computing device 200 includes a storage device 215 includes storage for storing data or instructions. As an example, and not by way of limitation, storage device 215 can comprise a non-transitory storage medium described above. The storage device 215 may include a hard disk drive (HDD), flash memory, a Universal Serial Bus (USB) drive or a combination of these or other storage devices.

The computing device 200 also includes one or more input or output (“I/O”) devices/interfaces 220, which are provided to allow a user to provide input to (such as user strokes), receive output from, and otherwise transfer data to and from the computing device 200. These I/O devices/interfaces 220 may include a mouse, keypad or a keyboard, a touch screen, camera, optical scanner, network interface, modem, other known I/O devices or a combination of such I/O devices/interfaces 220. The touch screen may be activated with a writing device or a finger.

The I/O devices/interfaces 220 may include one or more devices for presenting output to a user, including, but not limited to, a graphics engine, a display (e.g., a display screen), one or more output drivers (e.g., display drivers), one or more audio speakers, and one or more audio drivers. In certain implementations, devices/interfaces 220 is configured to provide graphical data to a display for presentation to a user. The graphical data may be representative of one or more graphical user interfaces and/or any other graphical content as may serve a particular implementation.

The computing device 200 can further include a communication interface 225. The communication interface 225 can include hardware, software, or both. The communication interface 225 can provide one or more interfaces for communication (such as, for example, packet-based communication) between the computing device and one or more other computing devices 200 or one or more networks. As an example, and not by way of limitation, communication interface 225 may include a network interface controller (NIC) or network adapter for communicating with an Ethernet or other wire-based network or a wireless NIC (WNIC) or wireless adapter for communicating with a wireless network, such as a WI-FI. The computing device 200 can further include a bus 230. The bus 230 can comprise hardware, software, or both that couples components of the computing device 200 to each other.

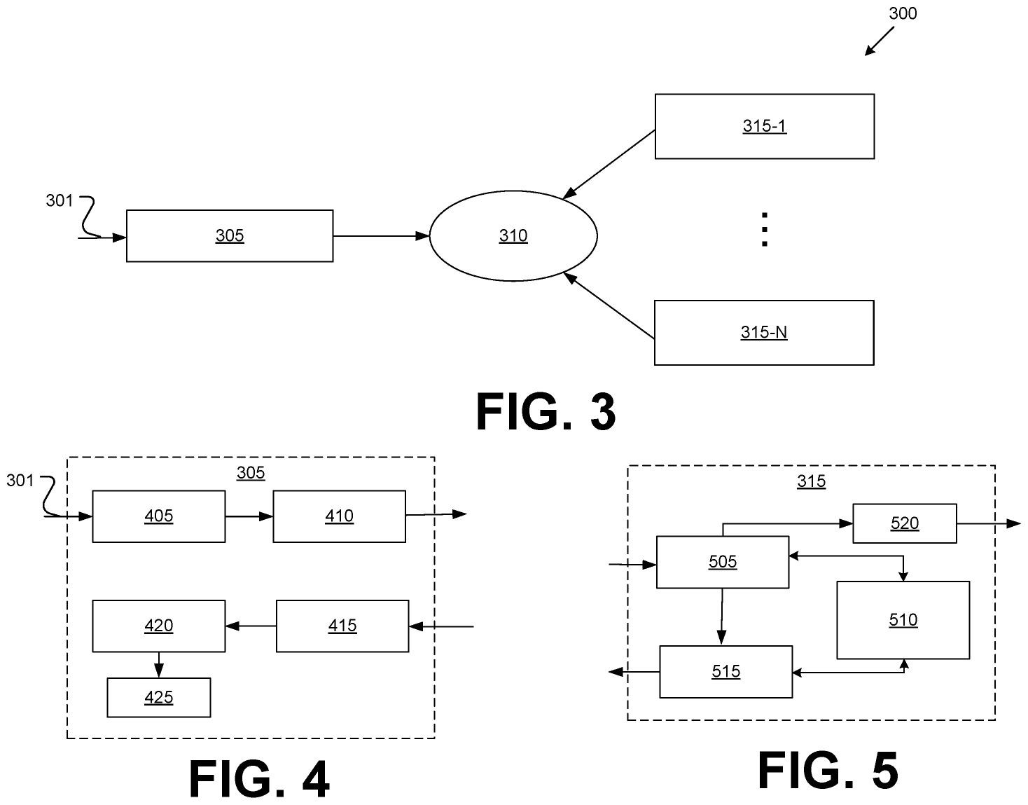

FIG. 3 illustrates an example state diagram 300 to discover resource providers via a discovery protocol. As shown, a resource requestor 305, i.e., the vehicle 105, can initiate a request based on a predefined policy. For example, the predefined policy may comprise the computer 110 detecting a presence of a server 145, a V2X device 150, or a computing device 155. The computer 110 can detect the presence of the server 145, the V2X device 150, or the computing device 155 when communication is established. In other example, the predefined policy may comprise the computer 110 determines that the vehicle 105, i.e., ego-vehicle is entering a predetermined driving scenario, such as entering a parking structure or an intersection. In yet another example, the predefined policy may comprise the computer 110 determining one or more computing resources of the computer 110 is predicted to be overloaded.

Upon determining that a request 301 is to be initiated, the resource requestor 305 initiates a discovery protocol 310 to discover one or more resource providers 315-1 to 315-N, where N is an integer equal to or greater than 1. As discussed herein, the discovery protocol 310 is used to determine whether at least one suitable remote resource provider 315-1 to 315-N can provide computing resources for the resource requestor 305. In other words, the resource requestor 305 can offload one or more computation processes to the at least one resource provider 315-1 to 315-N.

In an example implementation, the resource requestor 305 can transmit a resource query, collect responses from resource providers 315-1 to 315-N capable of providing the computational resources for sharing, off-load one or more computational processes, and maintain a record of capable resource providers 315-1 to 315-N.

The resource query, generated by the resource requestor 305, can be represented as M_s=<t_id, r_id, {res, spec}, strategy, incentive>, where t_id comprises an identifier of the request type, i.e., resource search for this type of message, r_id comprises a unique identifier of the resource requestor 305, {res, spec} comprises a data structure describing resources needed and corresponding specifications requested, i.e., CPU frequency >2 GHz, CPU utilization >20%, accelerator, gmac>3, Random Access Memory (RAM) size ≥2 GB, strategy comprises message transmission type, i.e., broadcast, multicast, unicast, and termination conditions, i.e., time-based, hop-count-based, first-match, time-to-live, etc., and incentive comprises an upper threshold of compensation for the remote computational resources used.

A resource registration response, generated by a remote resource provider 315-1 to 315-N, can be represented as M_r=<t_id, r_id, s_id, cost>, where t_id comprises an identifier of the request type, i.e., resource search response, r_id comprises a unique identifier of the resource requestor 305, s_id comprises a unique identifier of the resource provider 315-1 to 315-N, and cost comprises a cost for using the computation resources of the resource provider 315-1 to 315-N, i.e., $1/hour, $0.1*CPU %, etc.

FIG. 4 illustrates an example resource requestor 305 that receives a request 301 based on the predefined policy. A request generator 405 generates the resource query M_s after receiving the request 301. The resource query M_s is then provided to a request scheduler 410 that determines when to transmit the resource query M_s. The request scheduler 410 can schedule transmission of the resource query M_s according to a predefined transmission policy. The predefined transmission policy can comprise transmitting the resource query M_s to a set of predefined resource providers 315-1 to 315-N that are pre-authenticated, followed by subscription-based resource provider 315-1 to 315-N nodes, and so forth. The resource query M_s can then be transmitted according to the determined schedule.

A response listener 415 listens for resource registration response M_r for a predefined period of time. After receiving the resource registration response M_r, the response listener 415 provides the resource registration response M_r to a remote resource manager 420. It is understood that multiple and unique resource providers may transmit a separate registration response M_r in response to the resource query M_s.

The remote resource manager 420 stores data contained within the registration response M_r for each resource provider 315-1 to 315-N within a data structure 425. The data structure 425 can comprise a database, a lookup table, or the like. In some implementations, the remote resource manager 420 ranks each resource provider 315-1 to 315-N according to available resources, capacity, and/or cost. For instance, the remote resource manager 420 can dynamically rank resource providers 315-1 to 315-N according to available resources as a particular resource provider 315 is discovered.

The resource requestor 305 can then provide a resource identification command to the computer 110. Using the resource identification command, the computer 110 can offload one or more computational processes, such as processes related to mapping, object detection, object identification, etc., to the identified resource provider 315-1 to 315-N.

It is understood that the resource requestor 305 may transmit multiple unique resource requests M_s according to varying demands and/or onboard computing components. For example, the resource requestor 305 can transmit a first resource request M_s requesting computational resources for mapping and can transmit a second resource request M_s requesting computational resources for object detection.

FIG. 5 illustrates an example resource provider 315 that receives a resource request M_s at a request processor 505. The request processor 505 initially determines whether one or more termination conditions defined within the resource request M_s are met. For example, the request processor 505 determines whether a number of hops or a time-to-live has been exceeded. If at least one termination condition is met, the resource request M_s is discarded, i.e., ignored.

Otherwise, the request processor 505 accesses a resource record 510 to determine whether the resource provider 315 can meet the resources requested, i.e., resources and/or specifications defined within the {res, spec} data structure. The resource record 510 can comprise a data structure, such as a database, that stores resources available and/or computing specifications.

If the resources cannot be met, the resource request M_s can be discarded. In some implementations, if the resources cannot be met, the request processor 505 modifies the resource request M_s for forwarding purposes. For example, the resource provider 315 may be within a predefined distance to other resource providers that may be able to meet the requirements defined within the resource request M_s. In these instances, the request processor 505 can modify the termination conditions within the resource request M_s. For example, the request processor 505 may decrement a number of hops defined within the resource request M_s to account for the current resource provider 315. The request processor 505 can then provide the modified resource request M_s′ to a forwarding module 520, which can forward the modified resource request M_s′ to one or more selected resource provider 315.

Otherwise, the request processor 505 sends a response generation command to a response generator 515. The response generator 515 generates a registration response M_r.

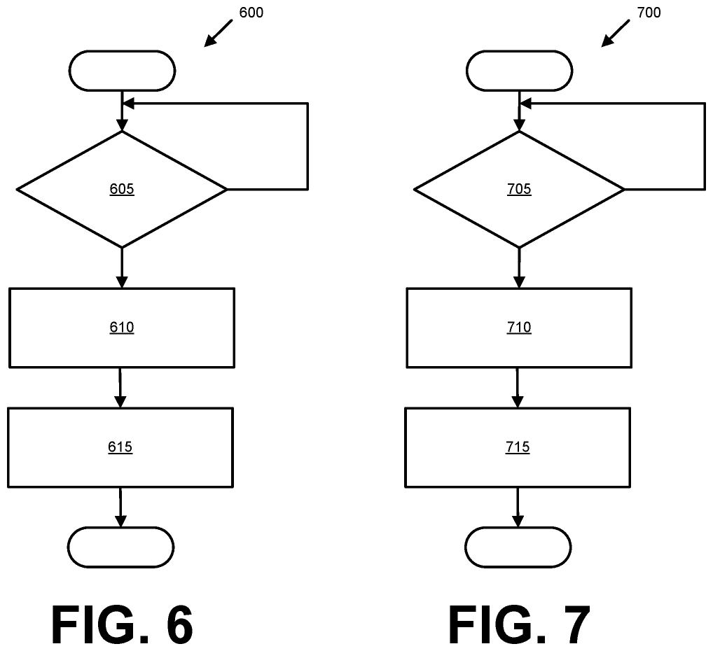

FIG. 6 illustrates an example process 600 for generating a resource query M_s. Blocks of the process 600 can be executed by the computer 110.

At block 605, a determination is made whether a request based on a predefined policy has been received. If not, the process 600 returns to block 605.

Otherwise, at block 610, a resource query M_s is generated.

At block 615, the resource query M_s is scheduled for transmission. The process 600 then ends.

FIG. 7 illustrates an example process 700 for discovering one or more devices, such as server 145, V2X device 150, and/or computing device 155, that can function as resource providers 315-1 to 315-N for the computer 110. Blocks of the process 700 can be executed by the computer 110.

At block 705, a determination is made whether a resource registration response M_r has been received. If not, the process 700 returns to block 705.

Otherwise, at block 710, data within the received registration response M_r for the corresponding resource provider 315 is stored in a data structure.

At block 715, the resource providers 315-1 to 315-N are ranked according to available resources, capacity, and/or cost. For example, the processor 110 can dynamically rank resource providers 315-1 to 315-N based on available resources included in the registration response M_r. The process 700 then ends

It is understood that the processor 110 can initiate one or more offload operations such that one or more computation processes are offloaded to one or more resource providers 315-1 to 315-N. For example, the processor 110 can offload computational processes based on the ranked resource providers. In some instances, the processor 110 initiates multiple offload operations such that mapping computational processes are provided to a first resource provider 315 and such that object detection computation processes are provided to a second resource provider 315.

The description of the present disclosure is merely exemplary in nature and variations that do not depart from the gist of the present disclosure are intended to be within the scope of the present disclosure. Such variations are not to be regarded as a departure from the spirit and scope of the present disclosure.

In general, the computing systems and/or devices described may employ any of a number of computer operating systems, including, but by no means limited to, versions and/or varieties of the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computers and computing devices generally include computer executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc.

Memory may include a computer readable medium (also referred to as a processor readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain implementations, and should in no way be construed so as to limit the claims.

Accordingly, it is to be understood that the above description is intended to be illustrative and not restrictive. Many implementations and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future implementations. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

1. A system comprising a computer including a processor and a memory, the memory including instructions such that the processor is programmed to:
generate a resource query, the resource query including at least a request for resources to offload at least one computation process and at least one termination condition, the resource query further including an incentive that includes an upper threshold of compensation for using remote computational resources of an at least one remote resource provider;
transmit the resource query to the at least one remote resource provider; and
initiate an offload operation to offload the at least one computation process based on a received resource request.

2. The system of claim 1, wherein the termination condition comprises at least one of a time-based termination condition, a hop-count-based termination condition, a first-match termination condition, or a time-to-live termination condition.

3. (canceled)

4. The system of claim 1, wherein the processor is further programmed to rank a plurality of resource providers based on resource requests received from the plurality of resource providers.

5. The system of claim 1, wherein the at least one remote resource provider comprises at least one of an edge server, a V2X device, or a mobile computing device.

6. The system of claim 1, wherein the processor is further programmed to generate the resource query according to a predefined policy.

7. The system of claim 6, wherein the predefined policy comprises at least one of detecting a presence of the at least one remote resource provider, whether an ego-vehicle is entering a predetermined driving scenario, or one or more computing resources is predicted to be overloaded.

8. The system of claim 1, wherein the processor is further programmed to transmit the resource query to a set of pre-authenticated resource providers according to a predefined transmission policy.

9. The system of claim 1, wherein the at least one remote resource provider is configured to access a resource record to determine whether the at least one remote resource provider can provide computational resources defined within the resource query.

10. The system of claim 9, wherein the at least one remote resource provider is configured to discard the resource query when the at least one remote resource provider determines that it cannot provide sufficient computational resources.

11. The system of claim 1, wherein the at least one remote resource provider is configured to determine whether the at least one termination condition is met after receiving the resource request.

12. The system of claim 11, wherein the at least one remote resource provider is configured to discard the resource query when the at least one termination condition is met.

13. A method comprising:
generating a resource query by a resource requestor in a vehicle, the resource query including at least a request for resources to offload at least one computation process and at least one termination condition, the resource query further including an incentive that includes an upper threshold of compensation for using remote computational resources of an at least one remote resource provider, wherein the at least one remote resource provider is another vehicle or infrastructure;
transmitting the resource query to the at least one remote resource provider via a vehicle-to-vehicle or vehicle-to-infrastructure communication;
receiving, by the resource requestor, a resource registration response from the at least one remote resource provider, wherein the resource registration response includes a cost for using the computation resources of the resource provider;
receiving multiple registration responses from multiple remote resource providers and ranking the multiple remote resource providers in part based on the cost for using the computation resources of the resource provider; and
initiating an offload operation to offload the at least one computation process based on the received resource registration response from the remote resource provider.

14. The method of claim 13, wherein the termination condition comprises at least one of a time-based termination condition, a hop-count-based termination condition, a first-match termination condition, or a time-to-live termination condition.

15. The method of claim 13, the method further comprising transmitting the resource query to a set of pre-authenticated resource providers according to a predefined transmission policy.

16. The method of claim 13, wherein the at least one remote resource provider is configured to access a resource record to determine whether the at least one remote resource provider can provide computational resources defined within the resource query.

17. The method of claim 16, wherein the at least one remote resource provider is configured to discard the resource query when the at least one remote resource provider determines that it cannot provide sufficient computational resources.

18. The method of claim 13, wherein the at least one remote resource provider is configured to determine whether the at least one termination condition is met after receiving the resource request.

19. The method of claim 18, wherein the at least one remote resource provider is configured to discard the resource query when the at least one termination condition is met.

20. (canceled)

21. The method of claim 13, wherein the cost for using the computation resources of the resource provider is one of dollar per hour or dollar per CPU percentage.
